(19) United States
(12) Patent Application Publication
(10) Pub. No.: US 2009/0055054 A1
(43) Pub. Date: Feb. 26, 2009

(54) METHOD AND DEVICE FOR ACTIVATING PASSENGER PROTECTION MEANS

(76) Inventors: Michael Bunse, Vaihingen/Enz (DE); Marcel Schneider, Suzhou/Jiangsu (CN); Christian Rauh, Muenchen (DE); Vincent Judalet, Ludwigsburg (DE)

Correspondence Address: KENYON & KENYON LLP, ONE BROADWAY, NEW YORK, NY, 10004, US

(21) Appl. No.: 12/088,997

(22) PCT Filed: Oct. 27, 2006
(86) PCT No.: PCT/EP2006/067864

§ 371 Date: Sep. 15, 2008

(30) Foreign Application Priority Data
Nov. 25, 2005 (DE) 10 2005 056 203.5

(51) Int. Cl. B60R 22/00

(52) U.S. Cl. 701/47

(57) ABSTRACT

A device and a method for activating passenger protection means are described in which an acceleration sensor system which is sensitive in the vehicle longitudinal direction generates a first signal and a second acceleration sensor system which is sensitive in the vehicle transverse direction generates a second signal. Furthermore, an analyzer circuit is provided which activates the passenger protection means as a function of the first and second signals, the analyzer circuit (μC) determining at least one measure for vibrational energy occurring during a crash and deciding for activation as a function of this measure.

### BACKGROUND INFORMATION

The present invention relates to a method and a device for activating passenger protection means according to the definition of the species in the independent patent claims.

A method is known from GE 2369708 A with which a plausibility of a frontal crash event is checked by comparing acceleration values in the vehicle transverse direction, which are recorded by peripheral sensors, with a threshold. Only when this plausibility check is positive is a triggering decision, which is indicated by an acceleration signal in the vehicle longitudinal direction, allowed.

### SUMMARY OF THE INVENTION

The device according to the present invention and the method according to the present invention for activating passenger protection means, having the features cited in the independent patent claims, have the advantage over the related art that the plausibility check may take place quicker by utilizing the vibrations occurring during a crash for the plausibility check. This means that the acceleration values are not directly analyzed, but rather the vibrational energy or a measure for the vibrational energy is ascertained and used for the plausibility check.

Advantageous improvements on the device and the method for activating passenger protection means cited in the independent patent claims are possible through the measures and refinements listed in the dependent claims.

It is particularly advantageous that the measure for the vibrational energy is compared with particular threshold values, the particular threshold values being applied to belt tensioners and airbags. These threshold values may be constant or also time-dependent, or they may be variable as a function of other variables such as the vibrational energy itself or variables derived therefrom. In this case it is an adaptive threshold value.

Moreover, it is advantageous that the analyzer circuit, which may be a microcontroller in a control unit for activating passenger protection means, uses the variance of the acceleration signals of the peripheral sensors to determine the measure for the vibrational energy. It is alternatively possible that other suitable variables are also determined in order to record the vibrational energy.

The acceleration sensors, whose signal is used for determining the measure for the vibrational energy, are advantageously situated on the sides of the vehicle, preferably in the A, B, C pillar, or the side panels, or also on the seat support member or the door sills.

### DRAWING

Exemplary embodiments of the present invention are illustrated in the drawings and explained in greater detail in the following description.

FIG. 1 shows a block diagram of the device according to the present invention,

FIG. 2 shows a flow chart, and

FIG. 3 shows a block diagram.

### DESCRIPTION OF THE INVENTION

Methods for activating passenger protection means and similar devices analyze a variable in order to determine whether the passenger protection means such as airbags, belt tensioners, roll-over bars, crash-active head rests, etc. should be activated; a plausibility check must additionally take place so that activation actually occurs only in a real triggering case. This plausibility check is mostly carried out via the signal of a different sensor than the sensor whose signal is used for the activation decision itself. In the present case, a configuration is used in which the activation decision is formed as a function of a signal of an acceleration sensor which is sensitive in the vehicle transverse direction. This acceleration sensor may be situated in a centrally located control unit, for example, or situated outside the control unit and then also centrally located in a sensor box, for example. This signal may be the acceleration signal, the integrated acceleration signal, or the added-up acceleration signal, or the mean value of the acceleration signal, or the twice integrated acceleration signal, or an equivalent variable which is determined using a threshold value which may be fixed or variable. The signal of an acceleration sensor system which is sensitive in the vehicle transverse direction is used as the plausibility check signal. The signal of peripherally located acceleration sensors is used in particular for this purpose, i.e., these sensors are situated on the sides of the vehicle. The vibrational energy generated during a crash is determined from the signal, the vibrational energy being an early measure for the occurrence of a crash.

Also in the event of a strictly frontal crash, this analysis allows for an early plausibility check.

If one considers the vehicle structure as a first approximation under the condition of small deflections due to vibrations as following Hooke's spring law, it results, for example, in a differential equation for small deflections in the vehicle transverse direction of the B-pillar:

F=m·ÿ=−D·y

The solution of this differential equation for a free vibration is:

y=y₀·sin (ω·t); ÿ=ω²·y₀·sin (ω·t)

The potential energy of the vibration is in the deflection against the spring force:

$${E}_{pot} = \int F d y = - \int D \cdot y d y = - \frac{1}{2} {Dy}^{2} = - \frac{m}{2} {\ddot{y}}^{2}$$

For considering short periods and rapid events, the mean acceleration is also computed. This results in the variance criterion for N=16 measuring values, for example, with:

$$\frac{1}{N} {\sum }_{n = 1}^{N} {( {\ddot{y}}_{n} - \overline{\ddot{y}} )}^{2}$$

For computing reasons, a multiple of this value may be used for the sake of simplification.

If this variance criterion of at least one peripheral acceleration sensor exceeds an applicable threshold, the conclusion is drawn of a mechanical event in the vehicle which causes a vibration having a considerable energy content. A plausibility check of the triggering decision of an algorithm for activating passenger protection means for a frontal crash may be carried out on the basis of longitudinal acceleration signals, for example. The applicable threshold may be selected differently for each restraining means or passenger protection means such as a belt tensioner or an airbag in order to achieve a plausibility check as early as possible or also a high sturdiness of the triggering decision.

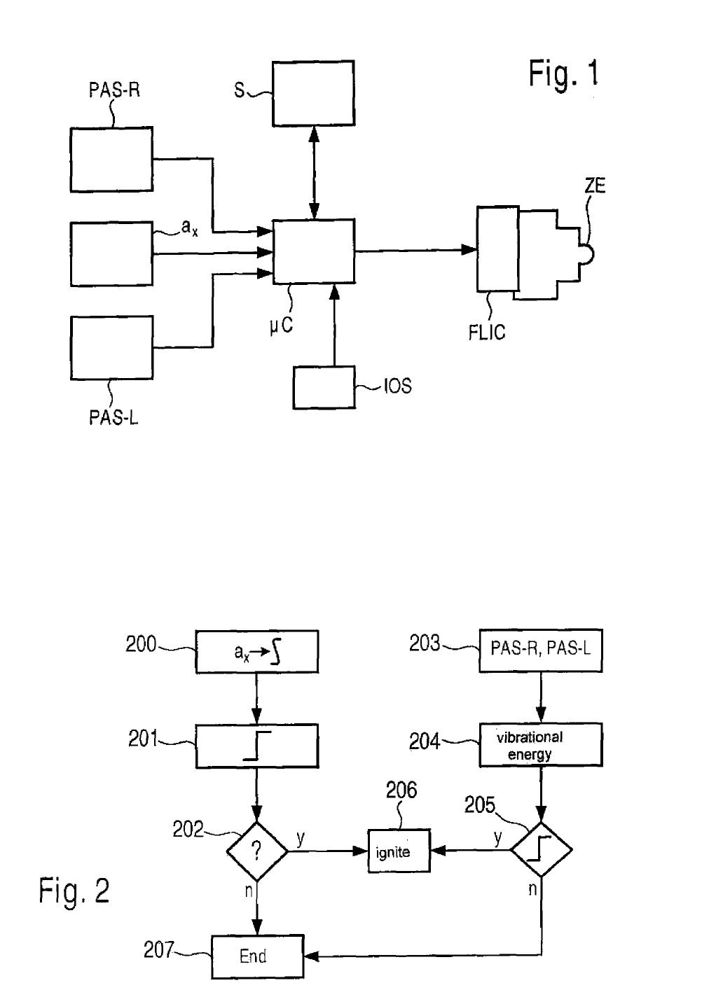

FIG. 1 shows a block diagram of the device according to the present invention. An acceleration sensor ax which is sensitive in the vehicle transverse direction is connected to a microcontroller μC which is situated in a control unit for activating passenger protection means, for example. This sensor ax may be situated inside the control unit or outside the control unit. In particular, acceleration sensor ax does not have to be sensitive in the vehicle longitudinal direction only; it may also be at an angle to the vehicle longitudinal direction. It is also possible that multiple sensors form acceleration sensor ax, these acceleration sensors being at an angle to the vehicle longitudinal direction at a 45° angle or at another angle. It is also possible that more than one acceleration sensor is situated in the vehicle longitudinal direction. Interface modules and redundant analysis in the control unit are not shown here for the sake of simplicity. Peripherally situated acceleration sensors PAS-R and PAS-L are also connected to microcontroller μC. These are situated right and left on the vehicle, in the B-pillar for example. Via a data input/output, microcontroller μC is connected to a memory S which it uses for analyzing the sensor signals and in which the appropriate algorithms are stored, i.e., memory S represents read-write and read-only memories. However, microcontroller μC does not analyze the acceleration signals only, but also signals of other sensors such as occupant classification or occupant identification sensors OCS which may be implemented via force measuring elements. But other sensors such as surroundings sensors or other impact or contact sensors may also be additionally used here. An Electronic Stability Program may also contribute data. Microcontroller μC activates an ignition element ZI via an ignition circuit activator FLIC as a function of all these data. A pyrotechnically activatable ignition element is shown here such as is typical for a pyrotechnically activatable belt tensioner or airbag. However, reversible restraining means are also activatable, e.g., a reversible, i.e., a belt tensioner activatable using an electric motor or a crash-active head rest which is also electromagnetically activatable.

The operating mode of this device is explained based on the following flow chart. The acceleration signal obtained by acceleration sensor ax is summed up in method step 200 and compared with an adaptive threshold value in method step 201. Adaptive means that the threshold value is altered as a function of the acceleration signal itself. However, other analyzing algorithms are also possible. It is checked in method step 202 whether or not this condition, which is ultimately decisive for activating passenger protection means, has been met. If it is not met, then the method is terminated in method step 207. However, if it is met, the system branches to method step 206 and only when the plausibility check is also positive is activation decided in method step 206. This plausibility check is started in method step 203 by picking up or generating the signals of peripheral sensors PAS-R and PAS-L and computing the vibration energy therefrom in method step 204 via the variance, using the method described above as an example. In method step 205, the vibrational energy is then subjected to a threshold value examination, namely the vibrational energies which have been determined based on the signals of acceleration sensors PAS-R and PAS-L. If only one threshold value is exceeded then the plausibility check criterion is met and ignition may be decided in method step 206. However, if none of the criteria is met, then the method is terminated in method step 207. Of course, the triggering decision is made separately for each passenger protection means and the corresponding thresholds are applied for the plausibility check, i.e., the methods for the airbag or the belt tensioner are run through in parallel. If the passenger protection means have different stages, then these methods also run through different stages.

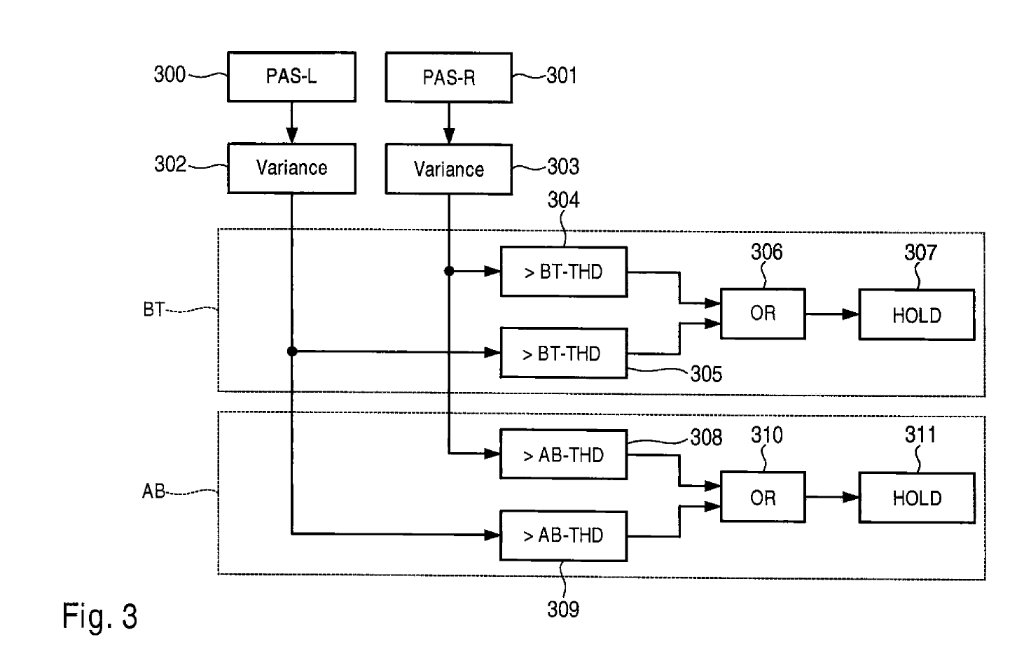

The plausibility checking method is explained in greater detail in the block diagram according to FIG. 3. The signal of peripheral acceleration sensor PAS-L is generated in method step 300 and the acceleration signal of peripheral acceleration sensor PAS-R is generated in method step 301. In method step 302, the acceleration signal of peripheral acceleration sensor PAS-L is supplied to the above-described variance criterion. This variance which represents the vibrational energy is supplied to threshold values in method steps 305 and 309. The acceleration signal of peripheral acceleration sensor PAS-R is supplied to the above-described variance criterion in method step 303. The variance thereby determined is supplied to threshold value deciders 304 and 308. Threshold value deciders 304 and 305 are set for the belt tensioner and connected to an OR-gate 306. Gate 307 holds the value determined in this way; i.e., if only one of threshold values 304 or 305 is exceeded by one of the determined variance criteria, then the belt tensioner is activated. This is correspondingly true for airbag AB. If only one of threshold values 308 or 309 is exceeded and since threshold value deciders 308 and 309 are connected via the outputs to an OR-gate 310 which in turn is connected to a HOLD-gate 311, then the plausibility check criterion is met. The threshold values for the belt tensioners or the airbags may be adaptive, i.e., as a function of the variance criterion or the acceleration signals, for example.

1-7. (canceled)

8. A device for activating a passenger protection device, comprising:
an acceleration sensor system sensitive in a vehicle longitudinal direction and adapted to generate a first signal;
a second acceleration sensor system sensitive in a vehicle transverse direction and adapted to generate at least one second signal; and
an analyzer circuit adapted to activate the passenger protection device as a function of the first and second signals, the analyzer circuit adapted to determine at least one measure for vibrational energy occurring during a crash, and decide for activation as a function of the at least one measure.

9. The device as recited in claim 8, wherein the analyzer circuit is adapted to activate at least one of a belt tensioner and an airbag, the analyzer circuit adapted to compare the at least one measure for the at least one of the belt tensioner and the airbag with at least one respective threshold value and to decide for activation as a function of the comparison.

10. The device as recited in claim 8, wherein the analyzer circuit is adapted to determine the at least one measure as a function of a variance of the second signal.

11. The device as recited in claim 8, wherein the second acceleration sensor system has at least one acceleration sensor on a left side and a right side of the vehicle.

12. A method for activating a passenger protection device, comprising:
generating a first signal of a first acceleration sensor system which is sensitive in the vehicle longitudinal direction;
generating at least one second signal of a second acceleration sensor system which is sensitive in the vehicle transverse direction; and
activating the passenger protection device via an analyzer circuit which determines at least one measure for vibrational energy occurring during a crash as a function of the first and second signals and decides for activation as a function of the measure.

13. The method as recited in claim 12, wherein the at least one measure is compared with at least one respective threshold value for activating at least one of a belt tensioner and an airbag.

14. The method as recited in claim 12, wherein the at least one measure is determined as a function of a variance of the second signal.
